(19) United States
(12) Patent Application Publication
(10) Pub. No.: US 2015/0164113 A1
(43) Pub. Date: Jun. 18, 2015

(54) REDUCING THE ANTINUTRITIONAL FACTORS IN A FOOD GRAIN

(71) Applicant: NESTEC S.A., Vevey (CH)

(72) Inventors: Alice Moroni, Lausanne (CH); Edwin Ananta, Epalinges (CH); Carl Erik Hansen, Epalinges (CH); Jean-Yves Chuat, Prilly (CH)

(73) Assignee: NESTEC S.A., Vevey (CH)

(21) Appl. No.: 14/414,767

(22) PCT Filed: Jul. 26, 2013
(86) PCT No.: PCT/EP2013/065774

§ 371 Date: Jan. 14, 2015

(30) Foreign Application Priority Data
Jul. 26, 2012 (EP) 12177983.9

(51) Int. Cl. A23L 1/105; A23L 1/20; C12R 1/25

(52) U.S. Cl. CPC A23L 1/105; C12R 1/25; A23L 1/2008; A23V 2002/00; A23Y 2220/67; A23Y 2220/43; A23Y 2220/73; A23Y 2220/63; A23Y 2300/55; A23Y 2300/49; A23Y 2240/75

(57) ABSTRACT

The present invention relates to a method for improving the nutritional value of a food grain. In particular, the invention relates to a novel method for reducing the antinutritional factors in a food grain. One aspect of the invention involves preparing a bacterial preparation containing viable lactic acid bacteria; and soaking the food grain in the bacterial preparation; wherein the lactic acid bacteria have been at least partially removed from the bacterial preparation before soaking. Further aspects of the invention are the bacterial strains Lactobacillus plantarum CNCM I-4635 (NCC 385)and Lactobacillus plantarum CNCM I-4636 (NCC 1582).

The present invention relates to a method for improving the nutritional value of a food grain. In particular, the invention relates to a novel method for reducing the antinutritional factors in a food grain. One aspect of the invention involves preparing a bacterial preparation containing viable lactic acid bacteria; and soaking the food grain in the bacterial preparation; wherein the lactic acid bacteria have been at least partially removed from the bacterial preparation before soaking. Further aspects of the invention are the bacterial strains Lactobacillus plantarum CNCM 1-4635 (NCC 1385) and Lactobacillus plantarum CNCM 1-4636 (NCC 1582).

The World Health Organization (WHO) identifies malnutrition as “the single most important risk factor for disease”. Malnutrition is not only caused by an insufficient amount of food, but may also be caused by a poor nutritional quality of the available food. This can be a particular problem with plant-based diets where the nutrients present in the food have a low bioavailability due to the presence of antinutritional factors such as phytic acid, polyphenols and oxalate. (C. Hotz, The Journal of Nutrition, 137, 1097-1100 (2007)). Food grains such as cereals provide a large proportion of the plant-derived foods consumed worldwide and so it is important to find efficient means to reduce the antinutritional factors in food grains and so increase the bioavailability of minerals such as calcium, zinc and iron. Iron deficiency is the most prevalent form of malnutrition worldwide, affecting millions of people. Iron deficiency can result in anaemia which is a global public health problem affecting both developing and developed countries.

An important antinutritional factor in food grains is phytic acid. Phytic acid is the major storage form of phosphorous in grains and it strongly binds metallic cations of Ca, Fe, K, Mg, Mn and Zn, making them insoluble and thus unavailable for nutrition ((Bohn L. et al., Journal of Zhejiang University Science B9, 165-191 (2008)). The presence of high amounts of phytic acid hinders the nutritional benefits of food grains and a complete removal of phytic acid is often required to improve mineral bioaccessibility and bioavailability. Traditionally a number of methods have been used to reduce antinutritional factors when processing food grains. Grinding cereal food grains can be used to remove bran and/or germ which may reduce their phytate content when the phytate is localized in the outer aleurone layer (e.g. rice, sorghum and wheat) or in the germ (i.e. maize) (C. Hotz, The Journal of Nutrition, 137, 1097-1100 (2007)). The flour produced by grinding may then be soaked or fermented to further reduce antinutritional factors. Hotz reports that soaking cereal flours and most legume flours in water can remove water-soluble phytate salts as well as some polyphenols and oxalates. Fermentation of the flour, for example to make sourdough bread, can induce phytate hydrolysis via the action of microbial and/or endogenous phytase enzymes. However, the bran and germ contain important nutritional components such as dietary fibre, minerals and antioxidants (phenolics, tocotrienols, phyto-oestrogens) which are generally lost or reduced when the food grains are ground into flour.

Liang reports that natural fermentation of whole brown rice grains (J. Liang et al., Food Chemistry, 110, 821-828 (2008)) can be used to reduce their phytic acid content. After three 24 hour cycles of inoculating fresh mixtures of rice and water with 10% of the water of the previously day's fermented mixture Liang was able to obtain an enriched fermentation starter and achieve a 95% reduction in phytic acid after a further 24 hours fermentation. However the use of natural fermentation and repeated starter enrichment cycles may not be ideal for an industrial process which needs to achieve a rapid and consistent result. Furthermore, this type of fermentation may be liable to contamination with associated food safety risks.

TW200721982 discloses a two-phase fermentation method for improving the nutritional benefits of soybeans. This involves fermenting raw soybeans with Aspergillus spp. before a further fermentation with lactic acid bacteria. However, it is not always desirable to have a two step process due to the additional manufacturing complexity involved, and the taste profile imparted by Aspergillus spp. may not be desired.

It would be desirable to have an alternative method for reducing the antinutritional factors in a food grain which does not necessarily require the food grain to be ground into flour and which can be performed in a limited number of steps, with good reproducibility, short processing times and/or an acceptable taste profile.

The object of the present invention is to improve the state of the art and to provide an alternative method to overcome at least some of the inconveniences described above. The object of the present invention is achieved by the subject matter of the independent claim. The dependent claims further develop the idea of the present invention. Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”.

Accordingly, the present invention provides a method for reducing the antinutritional factors in a food grain comprising preparing a bacterial preparation containing viable lactic acid bacteria; and soaking the food grain in the bacterial preparation; wherein the lactic acid bacteria have been at least partially removed from the bacterial preparation before soaking.

The inventors were surprised to find that soaking rice grains in a lactic acid bacteria fermentation broth reduced the grains' content of antinutritional factors, even when the bacterial cells had been removed from the broth. The inventors observed a reduction in the antinutritional factors phytic acid and raffinose after soaking rice grains, for example, in diluted fermentation broths of Lactobacillus johnsonii NCC 533, Lactobacillus plantarum NCC 1582 or Lactobacillus plantarum NCC 1385 from which the bacteria had been removed before soaking. The reduction of antinutritional factors was greater than could be obtained simply by soaking the rice in a mildly acidic solution.

Consequently the present invention relates in part to a method for reducing the antinutritional factors in a food grain comprising preparing a bacterial preparation containing viable lactic acid bacteria; and soaking the food grain in the bacterial preparation; wherein the lactic acid bacteria have been at least partially removed from the bacterial preparation before soaking.

Antinutritional factors are natural or synthetic substances found in food that have the potential to adversely affect health and growth by preventing the absorption of nutrients from the food, and/or which exert other deleterious effects when ingested. The method according to the present invention may reduce one or more antinutritional factors.

Food grains are small, hard, dry seeds (with or without hull or fruit layers attached) harvested for human food or animal feed. Types of food grains include cereal grains, pseudocereal grains or pulses. Cereal grains are caryopses, the fruits of members of the grass family. Examples of cereals include maize, sorghum, rice, wheat, barley, millet, oats, teff, wild rice and rye. Pseudocereal grains are the seeds of broadleaf plants that are used in much the same way as cereals. Examples of pseudocereals include amaranth, quinoa and buckwheat. Pulses (sometimes called grain legumes) are the seeds of legumes. Examples include pinto beans, bambara beans, mung beans, chickpeas, lentils and soybeans.

As used herein the term “lactic acid bacteria” designates a gram-positive, microaerophilic or anaerobic bacterium which ferments sugars with the production of acids including lactic acid, acetic acid and propionic acid. Lactic acid bacteria are found among Lactococcus species, Streptococcus species, Lactobacillus species, Leuconostoc species, Pediococcus species, Brevibacterium species, Enterococcus species, and Propionibacterium species as well as lactic acid producing bacteria belonging to the group of the strict anaerobic bacteria, bifidobacteria, i.e. Bifidobacterium species.

The lactic acid bacteria of the present invention may comprise bacteria of the genus Lactobacillus. They are a major part of the lactic acid bacteria group. A number of Lactobacillus species have been used in food production for hundreds if not thousands of years and so they have good consumer acceptance.

The lactic acid bacteria of the present invention may comprise bacteria selected from the group consisting of Lactobacillus johnsonii; Lactobacillus plantarum; Bifidobacteria longum; Bifidobacteria lactis; Lactobacillus rhamnosus; Lactobacillus paracasei; Streptococcus thermophilus and combinations of these. These species of lactic acid bacteria have all been used in fermented foods or as probiotics. The commercial production of these species also provides a convenient source of bacterial preparations for use in the method of the invention.

The lactic acid bacteria of the present invention may comprise bacteria selected from the group consisting of Lactobacillus plantarum CNCM I-4636 (NCC 1582), Lactobacillus plantarum CNCM I-4635 (NCC 1385), Lactobacillus johnsonii CNCM I-1225 (NCC 533), Lactobacillus rhamnosus CGMCC 1,3724 (NCC 4007) and combinations of these. The lactic acid bacteria of the present invention may comprise Lactobacillus plantarum, for example Lactobacillus plantarum CNCM I-4636 (NCC 1582) or Lactobacillus plantarum CNCM I-4635 (NCC 1385). The lactic acid bacteria of the present invention may comprise Lactobacillus johnsonii CNCM I-1225 (NCC 533).

The lactic acid bacteria of the present invention may comprise bacteria selected from the group consisting of Lactobacillus johnsonii CNCM I-1225 (NCC 533); Lactobacillus plantarum CNCM I-4636 (NCC 1582); Lactobacillus plantarum CNCM I-4635 (NCC 1385);Bifidobacteria lactis CNCM I-3446 (NCC 2818); Lactobacillus rhamnosus CGMCC 1,3724 (NCC 4007); Lactobacillus paracasei CNCM I-2116 (NCC 2461); Streptococcus thermophilus CNCM I-3915 (NCC 2496) and combinations of these.

Lactobacillus johnsonii NCC 533 is also named La1. It was deposited with the Collection Nationale de Cultures de Microorganismes (CNCM), Institut Pasteur, 25 rue du Docteur Roux, F-75724 PARIS Cedex 15, France, on 30 Jun. 1992 and given the deposit number I-1225.

Lactobacillus plantarum NCC 1385 was deposited with the Collection Nationale de Cultures de Microorganismes (CNCM), Institut Pasteur, 25 rue du Docteur Roux, F-75724 PARIS Cedex 15, France, on 29 May 2012 and given the deposit number I-4635.

Lactobacillus plantarum NCC 1582 was deposited with the Collection Nationale de Cultures de Microorganismes (CNCM), Institut Pasteur, 25 rue du Docteur Roux, F-75724 PARIS Cedex 15, France, on 29 May 2012 and given the deposit number I-4636.

Bifidobacteria lactis NCC 2818 was deposited with the Collection Nationale de Cultures de Microorganismes (CNCM), Institut Pasteur, 25 rue du Docteur Roux, F-75724 PARIS Cedex 15, France, on 7 June 2005 and given the deposit number I-3446.

Lactobacillus rhamnosus NCC 4007 was deposited with the China General Microbiological Culture Collection Centre (CGMCC), Chinese Academy of Sciences, PO Box 2714, Beijing 100080, P.R. China, in October 2004 and given the deposit number 1,3724.

Lactobacillus paracasei NCC 2461 was deposited with the Collection Nationale de Cultures de Microorganismes (CNCM), Institut Pasteur, 25 rue du Docteur Roux, F-75724 PARIS Cedex 15, France, on 12 January 1999 and given the deposit number I-2116.

Streptococcus thermophilus NCC 2496 was deposited with the Collection Nationale de Cultures de Microorganismes (CNCM), Institut Pasteur, 25 rue du Docteur Roux, F-75724 PARIS Cedex 15, France, on 5 Feb. 2008 and given the deposit number I-3915.

The bacterial preparation of the present invention may comprise an aqueous suspension of bacteria, for example bacteria growing in a liquid nutritional medium. Soaking the food grain in the bacterial preparation may include the addition of water to the bacterial preparation and/or the food grain.

Preferably the bacterial preparation before the at least partial removal of the lactic acid bacteria contains between 10⁵ and 10¹¹ colony forming units (CFU) per ml. In the present invention, “at least partially removed” means that at least 50% of the viable lactic acid bacteria present in the bacterial preparation have been removed, for example at least 80% of the viable lactic acid bacteria, or at least 90% of the viable lactic acid bacteria, or at least 99.9%. For example all viable lactic acid bacteria may have been removed. The bacterial preparation from which the lactic acid bacteria have been at least partially removed may have a cell count of less than 2000 CFU/ml. Examples of a bacterial preparation wherein the lactic acid bacteria have been at least partially removed may be a culture filtrate, or the supernatant of a culture after centrifugation. Such filtrates or supernatants may be concentrated or fractionated.

The bacterial preparation of the present invention may comprise a fermentation broth. The term fermentation broth refers to the culture medium resulting after fermentation of bacteria, including the bacteria and/or its component parts; unused raw substrates; and metabolites produced by the bacteria during fermentation. The fermentation broth may be a concentrated fermentation broth. Use of a fermentation broth is advantageous as the metabolites in the broth following fermentation with lactic acid bacteria include low molecular weight organic acids. These organic acids have the potential to enhance iron and zinc absorption via the formation of soluble ligands. They also reduce the pH which optimizes the activity of endogenous phytase from the cereal grains and helps to prevent the growth of unwanted yeasts and bacteria. Other metabolites include bacteriocins and antifungal peptides which also have a beneficial antimicrobial effect. Preferably the fermentation broth is a food grade fermentation broth, with all components appropriate for use in the preparation of food ingredients.

The bacterial preparation may be obtained as a by-product from the production of bacteria. Bacteria have many uses, including food preparation by fermentation, incorporation into food and healthcare products as probiotics and the production of pharmaceuticals and other chemicals. Often, once the bacterial cells have been removed or “harvested” from a fermentation broth, the rest of the broth is discarded. This is wasteful and it is often costly to ensure a safe and environmentally responsible disposal of the remaining broth. It is therefore an advantage that this by-product can be beneficially used in the current invention. The fermentation broth from which the bacterial cells have been removed may be diluted with water before soaking the grain. This makes economic sense as it allows one batch of fermentation broth to be used to soak many batches of grain. Also, it may be advantageous to dilute the fermentation broth to prevent the organic acids present in the broth imparting an acidic taste to the grain.

Antinutritional factors can adversely affect the protein and starch availability of food grains. Such antinutritional factors include protease inhibitors such as trypsin inhibitors; amylase inhibitors; polyphenols including tannins; and haemagglutinin lectin proteins (W. H. Holzapfel, Int. Journal of Food Microbiology, 75, 197-212 (2002)). Polyphenols may also inhibit iron absorption (Qianyi Ma et al., Journal of Nutrition, 140, 1117-1121 (2010)), and oxalates inhibit iron and calcium absorption (O. Faboya, Food Chem., 38, 179-187 (1990)). Oligosaccharides of the raffinose family of sugars are known to produce flatus in human and animals. The raffinose family of oligosaccharides are alpha-galactosyl derivatives of sucrose, and the most common are the trisaccharide raffinose, the tetrasaccharide stachyose, and the pentasaccharide verbascose. The raffinose family of sugars remains unhydrolyzed due to the absence of α-galactosidase enzyme activity which is capable of hydrolyzing the α-D-1-6 galactosidic linkage in the small intestine and hence they are not absorbed (S. E. Fleming, J. Food Sci. 46, 803 (1981)). Phytic acid (known as inositol hexakisphosphate or phytate when in salt form) is the principal storage forms of phosphorus in plant seeds. It is an antinutritional factor for humans and animals as it chelates cations such as Ca²⁺, Mg²⁺, Fe²⁺ and Zn²⁺ and complexes the basic amino acid group of proteins thus decreasing the bioavailability of these nutrients. The antinutritional factors reduced by the method of the present invention may be selected from the list consisting of trypsin inhibitors, tannins, oxalates, raffinose, stachyose, verbascose, phytic acid or combinations of these.

The soaking temperature affects the rate at which the antinutritional factors are removed from the food grain. As the temperature increases, the diffusion speed of components exchanging between the soaking liquid and the grain increases. For enzymatic processes there may be an optimum temperature for the enzyme activity. In the case of the degradation of phytate by phytase the optimum temperature would be around 55° C. However, higher temperatures are costly in terms of energy in an industrial soaking process. Accordingly, in the method of the present invention the food grain may be soaked at a temperature between 20° C. and 70° C., preferably between 30° C. and 60° C., more preferably between 35° C. and 55° C.

The present invention provides a quick and efficient method for reducing the antinutritional factors in a food grain. The soaking time will depend on the type of grain and the temperature used. The optimum time can be readily established by a skilled person and will generally be the shortest time which achieves the desired reduction in antinutritional factors. In the case of large-scale batch operations it may take time to fill and empty the soaking vessel and so not all parts of the food grain will experience the same soaking time. The times referred to here are average values.

In the present invention the food grain may be soaked for a period of between 10 minutes and 36 hours; between 30 minutes and 24 hours; between 1 hour and 12 hours; or between 2 hours and 6 hours.

It is beneficial to soak the food grain at an acid pH. The soaking temperatures between 20° C. and 60° C. are ideal for the growth of spoilage organisms but, by soaking at a low pH, the growth of unwanted yeasts and bacteria can be controlled. However, the pH should not be below 2, as this may affect the taste of the grain. An acid pH is also beneficial if any phytase is present (e.g. endogenous phytase from the food grain) as phytase activity is greatest below pH 7. In the method of the present invention the food grain may be soaked at a pH between 2 and 7; between 3 and 5.5; or between 3.5 and 4.5.

Fermentation with lactic acid bacteria produces low molecular weight organic acids which will naturally reduce the pH. However, it may be advantageous to control the pH for optimal reduction of antinutritional factors and inhibition of spoilage. The control of pH may be achieved using buffers. In the scope of this specification the term buffer includes any compound added to alter the pH, e.g. organic acids; as well as classical buffers, i.e. combinations of a weak acid with a corresponding salt to provide a composition resistant to changes in pH. In the method of the present invention the bacterial preparation may contain one or more buffers during soaking.

The food grain of the present invention may be in the form of whole grains. In the present invention, “in the form of whole grains” means that the grains are predominantly intact, for example they have not been pounded or milled. If the grains have started to germinate then their sprout growth does not exceed kernel length. In the case of cereals, whole grains are cereal grains that contain cereal germ, endosperm, and bran. Traditionally, grains have been milled to a flour before being fermented. Milling exposes nutrients in the grain for the bacteria to grow and better exposes antinutritional factors to the soaking liquid for extraction or decomposition. However, it is advantageous to be able to reduce the antinutritional factors in whole grains. Whole grains contain biologically-active compounds, such as dietary fibre, minerals, antioxidants (phenolics, tocotrienols, phyto-oestrogens) that may elicit health benefits either individually, in combination and/or synergistically. The inventors were surprised to find that that the method of the present invention is able to reduce the antinutritional factors in whole grains.

After soaking it is easier to drain the water from whole grains and then dry them than it is for flour, which tends to form a thick wet paste. Large quantities of whole grains may be soaked and then milled to produce a range of flours with different particle sizes which is more efficient than individually soaking each grade of flour. Whole grains may be used for further processing such as puffing. High pressure puffed grain is created by placing whole grains under high pressure with steam. The pressure is then rapidly released and the entrained steam flashes off and bloats the endosperm of the kernel, increasing its volume to many times its original size. There is also consumer demand for whole grains due to their health benefits. Although the component parts of whole grains may be recombined to form “whole grain” flour, consumers may doubt that they are getting all the components of the grain. By selling the grains intact it is clear to the consumer that they are really getting the whole grain. For food grains such as lentils, beans, rice and chickpeas, the consumer usually prefers to cook with the whole grains rather than a ground flour.

The food grain of the present invention is not particularly limited. The food grain may be selected from the group consisting of cereals, pseudocereals, legumes or combinations of these. More specifically, the food grain may be selected from the group consisting of rice; amaranth; wheat; barley; maize; sorghum; millet; oats; rye; buckwheat; quinoa; teff; wild rice; pinto bean; mung bean; bambara bean; chickpea; lentil; and soybean. All of these food grains contain antinutritional factors such as phytic acid and so it is advantageous that the method of the present invention can be used with these.

Rice is a staple food in many parts of the world, in particular Asia, and it is mainly consumed as polished rice. Unpolished or brown rice is a better source of fiber, iron, vitamins and minerals in comparison to polished rice. However, brown rice requires a long cooking time to be palatable. Brown rice is also rich in phytic acid but low in phytase which makes traditional soaking processes ineffective at reducing the antinutritional effects of phytic acid. The food grain of this invention may be brown rice. Advantageously, after the method of the invention has been applied, the brown rice takes less time to cook.

Further embodiments of the invention are the bacterial strains Lactobacillus plantarum CNCM I-4635 (NCC 1385) and Lactobacillus plantarum CNCM I-4636 (NCC 1582). These bacterial strains have surprisingly been found to be particularly effective at reducing the antinutritional factors in a food grain in the manner described in this specification.

Those skilled in the art will understand that they can freely combine all features of the present invention disclosed herein. In particular, features described for different embodiments of the present invention may be combined. Further advantages and features of the present invention are apparent from the non-limiting examples. Where known equivalents exist to specific features, such equivalents are incorporated as if specifically referred to in this specification.

### EXAMPLE 1

### Soaking Grains in Bacterial Preparations

Grain Soaking.

Fermentation broths were prepared for three different lactic acid bacterial strains; L. plantarum NCC 1582, L. plantarum NCC 1385 and L. johnsonii NCC 533. Each bacterial strain was subcultured twice in food grade broth to a final cell count between 10⁸ and 10⁹ cfu/ml. The broth containing the cells was centrifuged at 4,500 rpm and the supernatant was filtered using a filter with cut off at 0.22 μm. Brown rice grains (Brown rice round grain—PrimaVera Naturkorn GmbH) were then soaked in the bacterial preparations, the soaking liquid being 5 volumes of de-ionized water with the addition of 10% (v/v) of filtered broth supernatant. The grains were soaked for 24 hours at three temperatures; 30, 37 and 50° C. The cell counts and pH in the soaking medium were monitored every 6 hours. The detection limit (d.l.) for the cell counts was 2×10³ CFU/ml. At the end of the soaking process the grains were separated from the soaking medium and freeze dried.

For comparison, brown rice grains were soaked in a citrate (10 mM) buffer with a pH of 5. The grains were soaked for 24 hours at three temperatures; 30, 37 and 50° C.

Analyses of Antinutritional Factors

The freeze dried grains from the soaking experiments described above, together with unsoaked grains were analysed for phytic acid and raffinose content by an external laboratory; Agrobio of Rennes, France. The raffinose quantification was performed by ionic chromatography (Agrobio code 29.01) and the phytic acid quantification was by phytate extraction with phosphorous assay (Agrobio code 69.01). The detection limit for raffinose was 2 mg/100 g. The phytic acid quantification is the sum of all the different inositol phosphates (IP6 to IP1). The results are shown in the tables below.

TABLE 1
Rice grains soaked in lactic acid bacteria broths from which the
bacteria had been removed.

| | | Phytic | | | | |
|---|---|---|---|---|---|---|
| | | acid | % phytic | Raffinose | | Final cell |
| Soaking | Temp | (mg/ | acid | (mg/ | Final | count (log |
| medium | (° C.) | 100 g) | reduction | 100 g) | pH | CFU/ml) |
| Unsoaked | — | 987 | — | 33 | — | — |
| rice | | | | | | |
| L. plantarum | 30 | 502 | 49 | <d.l. | 4.4 | <d.l. |
| NCC 1582 | 37 | 441 | 55 | <d.l. | 4.5 | <d.l. |
| | 50 | 72 | 93 | <d.l. | 4.7 | <d.l. |
| L. plantarum | 30 | 525 | 46 | <d.l. | 4.4 | <d.l. |
| NCC 1385 | 37 | 358 | 63 | <d.l. | 4.3 | <d.l. |
| | 50 | 144 | 85 | <d.l. | 4.7 | <d.l. |
| L. johnsonii | 30 | 583 | 41 | <d.l. | 4.3 | <d.l. |
| NCC 533 | 37 | 553 | 44 | <d.l. | 4.4 | <d.l. |
| | 50 | 158 | 84 | <d.l. | 4.5 | <d.l. |

TABLE 2
Rice grains soaked in pH 5 citrate buffer.

| Temp | Phytic acid | % phytic acid | Raffinose |
|---|---|---|---|
| (° C.) | (mg/100 g) | reduction | (mg/100 g) |
| 30 | 722 | 27 | <d.l. |
| 37 | 773 | 22 | <d.l. |
| 50 | 319 | 68 | <d.l. |

The results show that soaking rice grains in a fermentation broth from which the bacterial cells have been removed reduces the content of phytic acid and raffinose in the rice. The bacterial preparations are more effective at reducing phytic acid than a pH5 buffer solution.

### EXAMPLE 2

### Soaking Grains in Bacterial Preparations—Buffered Growth Conditions

Fermentation broths were prepared for six different lactic acid bacterial strains; L. plantarum NCC 1582, L. plantarum NCC 1385, L. johnsonii NCC 533, B. lactis NCC 2818, B. longum BL999 and L. rhamnosus NCC 4007.

B. longum ATCC BAA-999 (BL999) may be obtained commercially from specialist suppliers, for example from Morinaga Milk Industry Co. Ltd. of Japan under the trade mark BB536.

The pH of the broths was controlled between pH 5 and 6 during growth. The broth containing the cells was then centrifuged at 4,500 rpm and the supernatant was filtered using a filter with cut off at 0.22 μm. Brown rice grains were soaked in the bacterial preparations (undiluted filtered broth supernatant). The grains were soaked for 24 hours at three temperatures; 30, 37 and 50° C. At the end of the soaking process the grains were separated from the soaking medium and freeze dried.

The broths after cell removal, but before soaking, were analyzed for lactic acid and acetic acid content by HPLC analysis and the pH measured. Some changes in pH from the controlled growth conditions were observed, this is believed to be due to small amounts of residual bacteria after centrifugation continuing to grow before being removed by subsequent filtration. The freeze dried grains were analyzed for phytic acid as in Example 1. The batch of rice used in Example 2 had a phytic acid content of 1020 mg/100 g. The results for the different strains are shown in the table below.

TABLE 3
Rice grains soaked in lactic acid bacteria broths from which the bacteria had
been removed; pH controlled during bacterial growth.

| | % Phytic acid | | | pH in broth | Lactic acid | Acetic acid |
|---|---|---|---|---|---|---|
| | reduction | | | before | before soaking | before |
| Soaking medium | 30° C. | 37° C. | 50° C. | soaking | (g/l) | soaking (g/l) |
| L. plantarum NCC 1582 | 67 | 83 | 97 | 5.5 | 32.7 | 0.4 |
| L. plantarum NCC 1385 | 71 | 87 | 97 | 5.5 | 36.4 | 0.4 |
| L. johnsonii NCC 533 | 70 | 79 | 79 | 3.7 | 31.2 | 0.3 |
| B. lactis NCC 2818 | 17 | — | 35 | 6.1 | 5.2 | 13.7 |
| B. longum BL999 | 37 | 45 | 32 | 4.7 | 18.5 | 17.6 |
| L. rhamnosus NCC 4007 | 18 | 38 | 65 | 5.6 | 56.6 | 0 |

For comparison, the brown rice grains were soaked in lactic acid solution at a concentration of 28 g/l.

TABLE 4
Rice grains soaked in lactic acid solution

| | % Phytic acid | | | |
|---|---|---|---|---|
| | reduction | | | |
| Soaking medium | 30° C. | 37° C. | 50° C. | pH |
| Lactic acid (35 g/l) | 32 | 31 | 30 | 2.6 |

The results show that bacteria of the genus Lactobacillus provide good results in reducing phytic acid content of brown rice, for example at 50° C. Lactobacillus plantarum strains provide particularly good reduction of phytic acid at all the temperatures studied, as does L. johnsonii NCC 533. By comparing with the rice soaked in a similar amounts of lactic acid it can be seen that the bacterial broths provide a greater reduction of phytic acid than could be accounted for by the simple action of producing lactic acid and lowering the pH.

1. Method for reducing the antinutritional factors in a food grain comprising: preparing a bacterial preparation containing viable lactic acid bacteria; and soaking the food grain in the bacterial preparation, wherein the lactic acid bacteria have been at least partially removed from the bacterial preparation before soaking.

2. A method according to claim 1 wherein the lactic acid bacteria comprise bacteria selected from the group consisting of Lactobacillus johnsonii; Lactobacillus plantarum; Bifidobacteria longum; Bifidobacteria lactis; Lactobacillus rhamnosus; Lactobacillus paracasei; Streptococcus thermophilus and combinations of these.

3. A method according to claim 1 wherein the lactic acid bacteria comprise bacteria selected from the group consisting of Lactobacillus johnsonii CNCM I-1225; Lactobacillus plantarum CNCM I-4636; Lactobacillus plantarum CNCM I-4635; Bifidobacteria lactis CNCM I-3446; Lactobacillus rhamnosus CGMCC 1,3724; Lactobacillus paracasei CNCM I-2116; Streptococcus thermophilus CNCM I-3915 and combinations of these.

4. A method according to claim 1, wherein the bacterial preparation comprises a fermentation broth.

5. A method according to claim 1, wherein the bacterial preparation is obtained as a by-product from the production of bacteria.

6. A method according to claim 1, wherein the antinutritional factor is selected from the group consisting of trypsin inhibitors, tannins, oxalates, raffinose, stachyose, verbascose, phytic acid and combinations of these.

7. A method according to claim 1, wherein the food grain is soaked at a temperature between 20° C. and 70° C.

8. A method according to claim 1, wherein the food grain is soaked for a period of between 10 minutes and 36 hours.

9. A method according to claim 1, wherein the food grain is soaked at a pH of between 2 and 7.

10. A method according to claim 1, wherein the food grain is in the form of whole grains.

11. A method according to claim 1, wherein the food grain is selected from the group consisting of cereals, pseudocereals, legumes and combinations of these.

12. A method according to claim 1, wherein the food grain is selected from the group consisting of rice; amaranth; wheat; barley; maize; sorghum; millet; oats; rye; buckwheat; quinoa; teff; wild rice; pinto bean; mung bean; bambara bean; chickpea; lentil; and soybean.

13. A method according to claim 12 wherein the rice is brown rice.

14. Lactobacillus plantarum CNCM I-4635.

15. Lactobacillus plantarum CNCM I-4636.
